(19) United States
(12) Patent Application Publication
(10) Pub. No.: US 2025/0157473 A1
(43) Pub. Date: May 15, 2025

(54) LLM AS A TRANSCRIPTION FILTER

(71) Applicant: Google LLC, Mountain View, CA (US)

(72) Inventors: Anupam Pathak, San Carlos, CA (US); Dongeek Shin, Mountain View, CA (US)

(21) Appl. No.: 18/506,038

(22) Filed: Nov. 9, 2023

(51) Int. Cl. G10L 17/00; G06F 16/34; G10L 21/10

(52) U.S. Cl. CPC G10L 17/00; G06F 16/345; G10L 21/10

(57) ABSTRACT

A user electronic device comprising: one or more microphones configured to capture raw audio data; and one or more processors and one or more storage devices storing instructions that when executed by the one or more computers cause the one or more computers to perform operations comprising: receiving the raw audio data captured by the one or more microphones; processing the raw audio data using a speech transcriber to generate a live transcription of the raw audio data that comprises a plurality of text tokens; processing the raw audio data to generate a speaker identification output that identifies, for each of the text tokens, a respective speaker for each of the text tokens in the live transcription; and processing a first input comprising (i) a first input prompt and (ii) an input text generated from the live transcription using a language model neural network to generate a modified transcription.

### BACKGROUND

This specification relates to data processing with large language models.

### SUMMARY

This specification describes a user electronic device that uses a language model that runs on device to generate modified transcriptions.

According to one aspect, there is provided a user electronic device comprising: one or more microphones configured to capture raw audio data; and one or more processors and one or more storage devices storing instructions that when executed by the one or more computers cause the one or more computers to perform operations comprising: receiving the raw audio data captured by the one or more microphones; processing the raw audio data using a speech transcriber to generate a live transcription of the raw audio data that comprises a plurality of text tokens; processing the raw audio data to generate a speaker identification output that identifies, for each of the text tokens, a respective speaker for each of the text tokens in the live transcription; generating an input text by modifying the live transcription to insert text identifying the respective speakers for each of the text tokens in the live transcription; and processing a first input comprising (i) a first input prompt and (ii) the input text generated from the live transcription using a language model neural network to generate a modified transcription.

In some implementations, the modified transcription is a corrected transcription that corrects transcription errors in the live transcription.

In some implementations, the operations further comprise: processing a second input comprising a second prompt for a text analysis task and context data comprising the corrected transcription and using the language model neural network to generate a text output for the text analysis task for the corrected transcription.

In some implementations, wherein the second prompt comprises an instruction to identify action items for a particular speaker, wherein the action items comprise (1) questions for the speaker to answer, (2) tasks for the speaker to complete, or both, and the text output comprises text derived from the corrected transcription that identifies one or more action items for the particular speaker.

In some implementations, the second prompt comprises an instruction to summarize the corrected transcript and the text output comprises text that summarizes the corrected transcript.

In some implementations, the first input prompt comprises an instruction to correct the live transcription.

In some implementations, the large language model provides a summary of the audio data at predetermined time intervals.

In some implementations, the operations further comprise determining that a specified time interval has elapsed since a prior live transcription of raw audio has been processed using the language model neural network; and processing the first input using the language model neural network in response to determining that the specified time interval has elapsed, wherein the live transcription is a transcription of raw audio captured during the specified time interval.

In some implementations, either the first input prompt or the second prompt or both include comprise an instruction to correct transcriptions generated from earlier live transcriptions of raw audio before the specified time interval.

In some implementations, operations further comprise: determining that transcribing has terminated; and, in response to determining that transcribing has terminated, processing a final input to generate text that summarizes the live transcription of raw audio data captured prior to, during, and after the specified time interval.

In some implementations, the plurality of text tokens comprise a set of speaker identifiers and a block of text associated with each speaker identifier.

In some implementations, the prompt comprises a query to correct the live transcription and one or more additional instructions.

In some implementations, the operations further comprise outputting the modified transcription to a user of the user electronic device.

In some implementations, the first input prompt further comprises an instruction to identify action items for a particular speaker.

In some implementations, the first input prompt further comprises an instruction to summarize the corrected transcript.

Recent advances in machine learning have enabled more accurate, smaller models for performing speech recognition to run directly on a user device. However, these existing models still suffer from missing words, accuracy issues, and lapses, limiting their use for long-running transcription. This has limited the utility of meeting transcriptions, note taking, or accessibility use cases (e.g. for hearing impairment, or memory loss) where a user would need to follow a conversation happening in real-time. It is beneficial to be able to correct transcription errors, insert additional information into a captured transcription, as well as summarize a captured transcription.

To address these issues, this specification describes using a language model that runs on device to perform near real-time filtering of errors, speaker identification, and summarization. This significantly enhances the accuracy and functionality of transcription models on a user device. Because the model runs on device, rather than in the cloud, the model can perform a variety of tasks with minimal latency and without needing to send transcription data to the cloud. This preserves user privacy, increases the security of the transcription data, allows for independence from remote resources, and offers control over resources and data.

Running the language model on device requires that the model runs with a smaller number of parameters than if it was run on the cloud. Live summarization is only possible when speech transcription is also run on device. This allows the model to run with greater speed. Language models are also very expensive to run and being able to run them on device with a smaller number of parameters saves compute resources. Running the language model on device takes advantage of on-device processing when the model is small enough to run on a device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example user device.

FIG. 2 is a flow chart of an example process for generating a modified transcription of raw audio data.

FIG. 3 is a flow chart is a detailed flow chart of an example process for generating a modified transcription of raw audio data.

FIG. 4 shows an example of a prompt and modified transcription.

FIGS. 5A and 5B show an example of a live transcription and a modified transcription generated by a user device.

Like reference numbers and designations in the various drawings indicate like elements.

### DETAILED DESCRIPTION

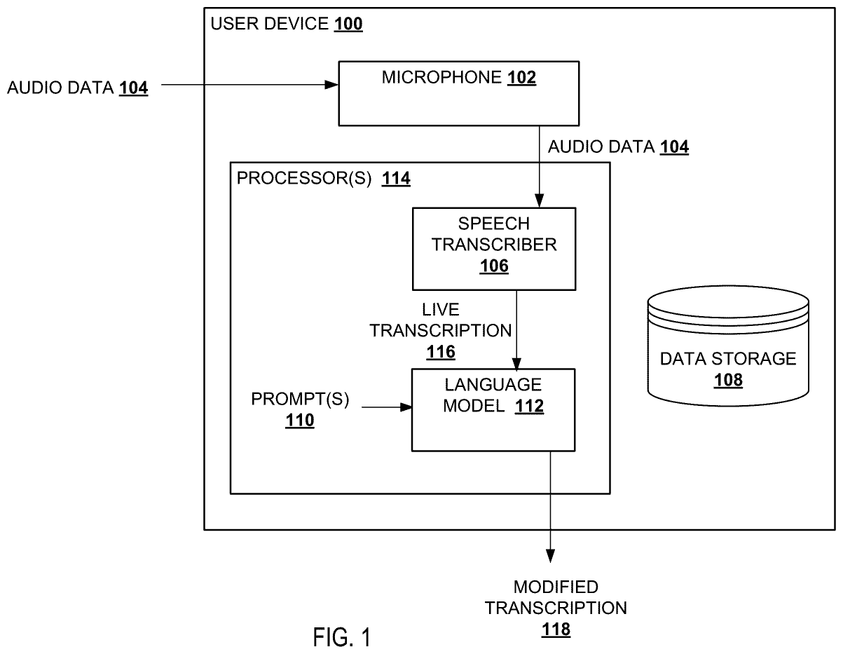

FIG. 1 is a block diagram of an example user device 100 that can process raw audio data and a prompt to generate a modified transcription of the audio data.

The user device includes one or more microphones 102, a data storage 108, and one or more processors 114.

Example user devices include personal computers, gaming devices, mobile communication devices, digital assistant devices, augmented reality devices, virtual reality devices, and other electronic devices.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

The user device 100 executes instructions stored in the data storage 108, which configures and enables the user device 100 to process raw audio data 104 and one or more prompts 110 to obtain a modified transcription 118 of the raw audio data.

The one or more microphones 102 are configured to capture raw audio data. The raw audio data can be an uncompressed representation of sounds made by one or more speakers. For example, the raw audio data can represent a conversation between two speakers such as an interview.

The user device includes one or more processors 114 that can receive the raw audio data.

The user device 100 can use a speech transcriber 106 to process the raw audio data and generate a live transcription of the raw audio data. The live transcription can include a plurality of text tokens that represents the words spoken by one or more speakers. The transcription is referred to as a “live” transcription because the transcription is generated in real time, i.e., in a streaming fashion, as the audio data is processed.

Because the transcription is “live,” the transcription may include errors and dropped text that may make the transcription difficult to understand for a human reader.

The speech transcriber 106 can be any appropriate speech to text tool. For example, the speech transcriber can be a software module that processes raw audio data to generate a plurality of text tokens that represent the raw audio data in real time. As another example, the speech transcriber can be a trained speech recognition machine learning model configured to or adapted to perform live transcription.

The user device 100 also includes a language model neural network 112. Although only one language model neural network 112 is depicted in FIG. 1, the language model neural network 112 can represent a set of multiple language models that can each be specially configured to perform certain tasks. For example, as described in more detail below, the set of language models represented by language model neural network 112 can include a large language model (“LLM”) that is configured to process a first input prompt and input text generated from a live transcription to generate a modified transcription.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code. For brevity, large language models are also referred to herein as “language models.”

The language model neural network 112 can be any appropriate neural network that receives an input sequence made up of text tokens selected from a vocabulary and auto-regressively generates an output sequence made up of text tokens from the vocabulary. For example, the language model neural network can be a Transformer-based language model neural network or a recurrent neural network-based language model neural network.

In some situations, the language model neural network 112 can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the language model neural network can process the current input sequence to generate a score distribution (e.g., a probability distribution) that assigns a respective score, e.g., a respective probability, to each token in the vocabulary of tokens. The language model neural network can then select, as the particular token, a token from the vocabulary using the score distribution. For example, the neural network of the language model can greedily select the highest-scoring token or can sample, e.g., using nucleus sampling or another sampling technique, a token from the distribution.

As a particular example, the language model neural network 112 can be an auto-regressive Transformer-based neural network that includes (i) a plurality of attention blocks that each apply a self-attention operation and (ii) an output subnetwork that processes an output of the last attention block to generate the score distribution.

The language model neural network 112 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring. S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

The processors 114 process a first input using the language model neural network 112 to generate an output that includes a modified transcription.

The first input can include an input prompt 110 that can include a instruction for the language model neural network 112. The instruction can be a natural language instruction or an example-based instruction The instruction can be an instruction to generate a corrected transcription, an instruction to highlight questions, an instruction to highlight next steps, or any other instruction regarding modifying text. The input prompt 110 can include one or more instructions. The prompt 110 can be an instruction-based prompt, a few shot prompt, or both. An instruction based prompt can be used to give the language model neural network a task or direction. A few shot prompt can enable in-context learning by providing one or more demonstrations to the language model neural network to improve its performance. For example, a demonstration for a summarization task can be a corrected transcription.

The first input also includes an input text that is generated from the live transcription. For example, the input text can be a version of the live transcription that includes embeddings that identify the text tokens associated with a particular speaker when there is more than one speaker in the raw audio data 104.

The input prompt 110 is submitted to the language model and causes the language model neural network 112 to generate output sequences that contain a modified transcription 118. For example, if the input prompt 110 includes a instruction to summarize a transcription, the modified transcription 118 can be a shortened version of the live transcription 116. As another example, if the input prompt 110 includes a instruction to correct grammatical errors and insert missing words in the live transcription 116, the modified transcription 118 can be a version of the live transcription that has any gaps in the transcription filled in.

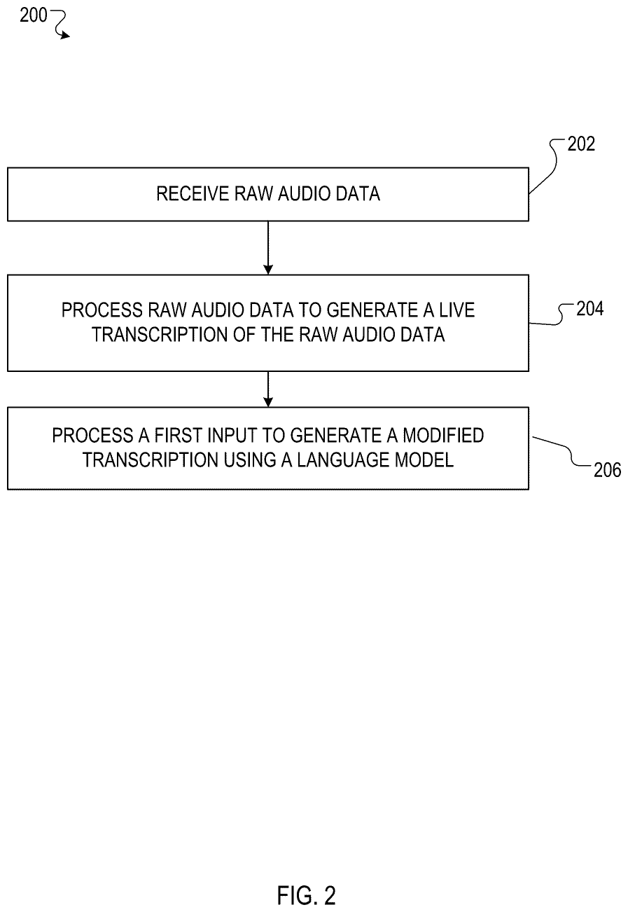

FIG. 2 is a flow chart of an example process 200 for generating a modified transcription of raw audio data. The process 200 can be executed by a user device, such as the user device 100 of FIG. 1, or a portion thereof.

The device can receive raw audio data captured by one or more microphones (step 202). The raw audio data can characterize a conversation between a plurality of users, a performance of a song, or sounds emitted by a single speaker.

The device can process the raw audio data using a speech transcriber to generate a live transcription of the raw audio data (step 204). The live transcription of the raw audio data includes a plurality of text tokens that characterize the raw audio data.

In some implementations, the plurality of text tokens that characterize the raw audio data can include a set of speaker identifiers and a block of text associated with each speaker identifier. For example, a speaker identifier can be a token that reads “Speaker 1” and the block of text can be “I would like to talk about my cat”. The plurality of text tokens can include a second speaker identifier that reads “Speaker 2” and have an associated block of text that reads “I think your cat is lovely”.

The device can generate the set of speaker identifiers using a speaker identification model or a model that jointly performs both speaker recognition and identification. In some examples, a user can manually input how many speakers are in a conversation. In other examples, the speech transcriber can learn how many speakers are in a conversation. The device can use the speech transcriber to number speakers using the audio embeddings by identifying when the voice that is currently speaking changes. As a conversation progresses, the speech transcriber can cluster words that are spoken by each voice and learn which words are associated with each speaker. The speaker identifiers can be numbers or names associated with each speaker. When the speaker identifier is a name, the name can be a manually entered name or a name from an account associated with a video call.

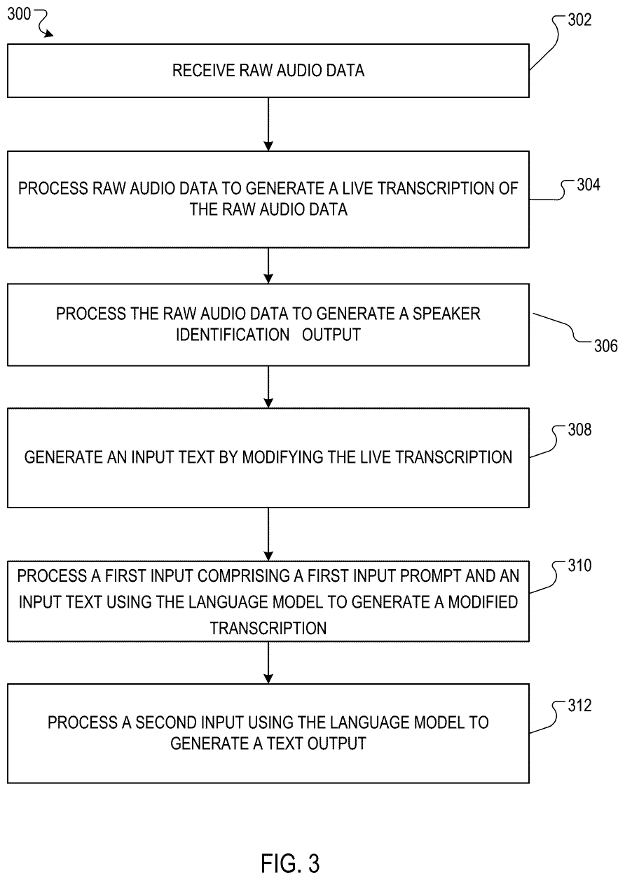

The device can then process a first input using a language model neural network to generate a modified transcription (step 206). The first input can include a first input prompt and an input text generated from the live transcription. Generating the input text is described in further detail below with reference to FIG. 3.

The first input prompt can include an instruction to correct the live transcription. The modified transcription can be a corrected transcription that corrects transcription errors in the live transcription. For example, the corrected transcription can include words that were missing in the live transcription or correct grammatical errors. The corrected transcription can also correct words that don't fit the context of the sentences that they are in. For example, the live transcription after being modified to include speaker identifiers can read:
“[Speaker 1] Nancy is detective and solves many mistresses is so clever. Shes the best character for roll model.
[Speaker 2] No I think it's Arwen elf and can sword and horse so well.” The associated modified transcription can read:
“[Speaker 1] Nancy is a detective and solves many mysteries and is so clever. She's the best character for a role model.
[Speaker 2] No, I think it's Arwen. She's an elf and can fight with a sword and ride a horse so well.”

The first input prompt can also include one or more additional instructions. In some implementations, the first input prompt can also include an instruction to identify action items for a particular speaker and the modified transcription can highlight questions or next steps for the particular speaker. For example, the live transcription can read:
“[Speaker 1] Chris, why did the client modify the second slide in our presentation? The edits don't make sense and are simply incorrect.
[Speaker 2] I'll have to get back to you, I'll send you an email with the answers tomorrow. It's so annoying when they make these kinds of edits without any context. I really wonder who they have looking at these.
[Speaker 1] Thanks, also please send me the name of whoever did this.
[Speaker 2] I got it, will do.”

The associated modified transcription can read “For Chris: Send document with the answers about presentation modification tomorrow, and send name”. In some examples the modified transcription can be the same as the live transcription, but with questions and action items underlined e.g.,
“[Speaker 1] Chris, why did the client modify the second slide in our presentation? The edits don't make sense and are simply incorrect.
[Speaker 2] I'll have to get back to you, I'll send you an email with the answers tomorrow. It's so annoying when they make these kinds of edits without any context. I really wonder who they have looking at these.
[Speaker 1] Thanks, also please send me the name of whoever did this.
[Speaker 2] I got it, will do.”

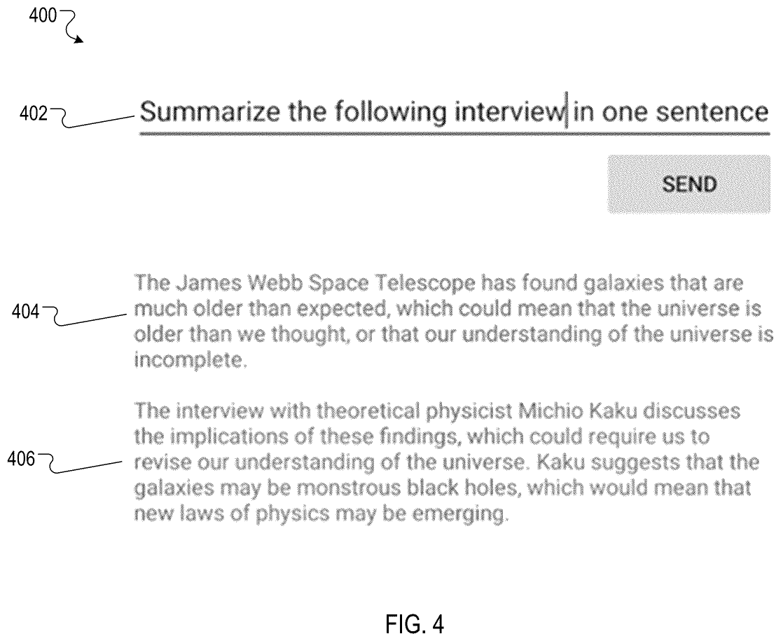

In some implementations, the first input prompt can also include a instruction to summarize the corrected transcript and the modified transcription can include a summary of the live transcription. Generating a modified transcription that includes a summary of the live transcription is described in more detail below with reference to FIG. 4.

In some implementations, the large language model can provide a summary of the audio data at predetermined time intervals. In these implementations, the device can determine that a specified time interval has elapsed since a prior live transcription of raw audio has been processed using the language model neural network. The device can process the first input using the language model neural network in response to determining that the specified time interval has elapsed. The live transcription can be a transcription of raw audio captured during the specified time interval.

In some implementations, the first input prompt can include a instruction to correct transcriptions generated from earlier live transcriptions of raw audio before the specified time interval.

In some implementations, the device can include corrected transcriptions generated from live transcriptions generated by the language model neural network as context information for the current input to the language model neural network. In some examples, the corrected transcriptions can be generated from earlier live transcriptions of raw audio before the specified time interval. The corrected transcriptions can be used to generate a corrected transcription for the specified time interval. In other examples, the corrected transcriptions can be used to complete other tasks e.g., summarization, question identification etc.

In some implementations, the device can determine that transcribing has terminated. The device can then process a final input to generate text that summarizes a live transcription of raw audio data captured prior to, during, and after the specified time interval.

In some implementations, the device can output the modified transcription to a user of the user electronic device.

In some implementations, the modified transcription can include, instead of numbers identifying speakers, names (e.g., “Chris”, “John”, etc.) or roles (e.g., “Interviewer”, “Professor”, etc.) that identify speakers. In some examples, the device can use the language model to learn the names or roles of the speakers using the live transcription as context. In other examples, the device can use audio-based diaration to distinguish one speaker from another. Speaker names can be inferred from the transcription or manually assigned.

FIG. 3 is a flow chart of an example process 300 for generating a modified transcription of raw audio data. The process 300 can be executed by a user device, such as the user device 100 of FIG. 1, or a portion thereof.

The device can receive raw audio data captured by the one or more microphones (Step 302).

The device can process the raw audio data using a speech transcriber to generate a live transcription of the raw audio data that comprises a plurality of text tokens (Step 304).

The device can process the raw audio data to generate a speaker identification output (Step 306). The device can generate audio-based speech embeddings to distinguish the voice of one person from another. The speaker identification output can identify, for each of the text tokens, a respective speaker for each of the text tokens in the live transcription. For example, the speaker identification output can identify a speaker number (e.g., Speaker 1, Speaker 2, etc.) associated with each of the text tokens in the live transcription. The device generates the set of speaker identifiers using the speech transcriber. In some examples, a user can manually input how many speakers are in a conversation. In other examples, the speech transcriber can learn how many speakers are in a conversation. The device can use a speaker identification model to number speakers using the audio embeddings by identifying when the voice that is currently speaking changes. As a conversation progresses, the speaker identification model can cluster words that are spoken by each voice and learn which words are associated with each speaker.

The device can generate input text by modifying the live transcription (Step 308). The device can insert text identifying the respective speakers for each of the text tokens in the live transcription to use as input text to a language model neural network. For example, if there are two speakers in a conversation, the device can insert “Speaker 1” and “Speaker 2” in the live transcription whenever the respective speaker begins to speak.

The device can process a first input using a language model neural network to generate a modified transcription (Step 310). The first input can include a first input prompt and an input text generated from the live transcription. The first input prompt can be a instruction to generate a corrected transcription.

The device can process a second input using the language model neural network to generate a text output for a text analysis task for the corrected transcription (Step 312). The second input can include a second prompt for a text analysis task and context data including the corrected transcription.

In some implementations, the second prompt can include an instruction to identify action items for a particular speaker. The action items can include questions for the speaker to answer, tasks for the speaker to complete, or both. The text output can include text derived from the corrected transcription that identifies one or more action items for the particular speaker. In some examples, the text output can include the text tokens from the corrected transcription with highlighted tasks. In other examples, the text output can include a list of questions for a particular speaker.

FIG. 4 shows an example 400 of a prompt 402 and modified transcription 404 that is generated by a user device. The prompt 402 reads “Summarize the following interview in one sentence” and the modified transcription reads “The James Webb telescope has found galaxies that are much older than expected, which could mean that the universe is older than we thought, or that our understanding of the universe is incomplete”.

The device can generate a live transcription using a speech transcriber that reads:
<Speaker 1> Next. My favorite kind of story in life is the kind that reminds us that we
<Speaker 2> are nowhere near as close to as smart as we think we are and oh boy does this next one. Do exactly that. You know that golden telescope with humans, built taking some mind blowing pictures of space right now <Speaker 1> or it turns out it's so powerful. It might have just shattered our understanding of the universe We've
<Speaker 2> all heard about how the new James Webb telescope is kind of like a time machine because it can look back to the early
<Speaker 1> going on in these images. It could pretty much
<Speaker 2> rewrite a whole bunch of physics textbooks. So of course we called up the legendary theoretical physicist who always has me dreaming of the cosmos and the author of a bunch of books that might need to be tweaked. Now, if it turns out that the universe is is older than we think, hey professor, I'm thinking of some of my favorites that got equation physics of the future of humanity. Most of them say the universe is about 13 billion years old. What if it's not? Well that's the problem. That James Webb Space Telescope is upsetting the Apple card. All of a sudden we realize that we may have to rewrite all the textbooks about the beginning of the universe. Now it takes many billions of years, to create a galaxy like a Milky Way. Galaxy with 100 billion stars many billions of years old but the James Webb Telescope has identified six galaxies that exist. Half a billion years after the Big Bang, better up to 10 times bigger than the Milky Way. Galaxy That shouldn't happen. They should not be primordial galaxies that are bigger than the Milky Way. Galaxy that are only half a billion years old. Something is wrong. We may have to revise our theory of the creation of the universe. <Speaker 1> Much older than we think it is. And we're also possibly looking at maybe this is an optical. Illusion is that are those are two options here. <Speaker 2> According to Einstein, gravity can act like glass the glass. Of course, you can make a magnifying glass with gravity. You too can bend space in time to create a gravity microwave, I mean, magnifying lens. So you think that these galaxies are huge when they're actually baby galaxies. Now, I personally think the solution of the problem is these are not baby galaxies at all. They're actually monstrous black holes, black holes, that formed after the instance of creation that's baffling scientists cuz they don't fit in the normal sequence of the birth of a galaxy. So I personally think that we're actually looking at monster black holes, where perhaps new laws of physics or emerging Waiting for you.
<Speaker 1> Galaxies are actually black holes. <Speaker 2> because we think that at the center of our own Milky Way. Galaxy the center of.

The live transcription includes many grammatical errors and missing sections. Additionally, while there are speaker identifiers, these incorrectly separate the words spoken by each speaker.

The device can use a language model neural network to generate a modified corrected transcription. For example, instead of reading
“<Speaker 1> going on in these images. It could pretty much <Speaker 2> rewrite a whole bunch of physics textbooks. So of course we called up the legendary theoretical physicist who always has me dreaming of the cosmos and the author of a bunch of books that might need to be tweaked. Now, if it turns out that the universe is is older than we think, hey professor, I'm thinking of some of my favorites that got equation physics of the future of humanity. Most of them say the universe is about 13 billion years old. What if it's not? Well that's the problem. That James Webb Space Telescope is upsetting the Apple card. All of a sudden we realize that we may have to rewrite all the textbooks about the beginning of the universe. Now it takes many billions of years, to create a galaxy like a Milky Way. Galaxy with 100 billion stars many billions of years old but the James Webb Telescope has identified six galaxies that exist. Half a billion years after the Big Bang, better up to 10 times bigger than the Milky Way. Galaxy That shouldn't happen. They should not be primordial galaxies that are bigger than the Milky Way. Galaxy that are only half a billion years old. Something is wrong. We may have to revise our theory of the creation of the universe. <Speaker 1> Much older than we think it is. And we're also possibly looking at maybe this is an optical. Illusion is that are those are two options here.”, the modified transcription can read: “<Interviewer> It could pretty much rewrite a whole bunch of astrophysics textbooks. So of course, we called up the legendary theoretical physicist Michio Kaku. He's the futurist who always has me dreaming of the cosmos and is the author of a bunch of books that might need to be tweaked now, if it turns out that the universe is older than we think. Hey professor! I'm thinking of some of my favorites: The God Equation, Physics of the Future, Future of Humanity. Most of them say the universe is about 13 billion years old. What if it's not?
<Michio Kaku> Well that's the problem. That James Webb Space Telescope is upsetting the Apple card. All of a sudden we realize that we may have to rewrite all the textbooks about the beginning of the universe. Now, it takes many billions of years to create a galaxy like a Milky Way Galaxy with 100 billion stars, many billions of years old. but the James Webb Telescope has identified six galaxies that exist half a billion years after the Big Bang that are up to 10 times bigger than the Milky Way Galaxy. That shouldn't happen. There should not be primordial galaxies that are bigger than the Milky Way Galaxy that are only half a billion years old. Something is wrong. We may have to revise our theory of the creation of the universe.
<Interviewer> And so we're also possibly looking at a universe that is much older than we think it is? And we're also possibly looking at maybe this is an optical illusion here? Are those the two options here?”.

The modified transcription be generated once when the conversation finishes or once per, for example, every 20 seconds. The language model neural network can use context from a previous modified transcript to correct a later iteration.

The device can process the modified transcription using the language model neural network to generate the summary 404.

If the prompt 402 read “Summarize the following interview” without the restriction of “in one sentence”, the summary could read “The James Webb telescope has found galaxies that are much older than expected, which could mean that the universe is older than we thought, or that our understanding of the universe is incomplete. The interview with theoretical physicist Michio Kaku discusses the implications of these findings, which could require use to revise our understanding of the universe. Kaku suggests that the galaxies may be monstrous black holes, which would mean that new laws of physics may be emerging.” as a longer summary 406.

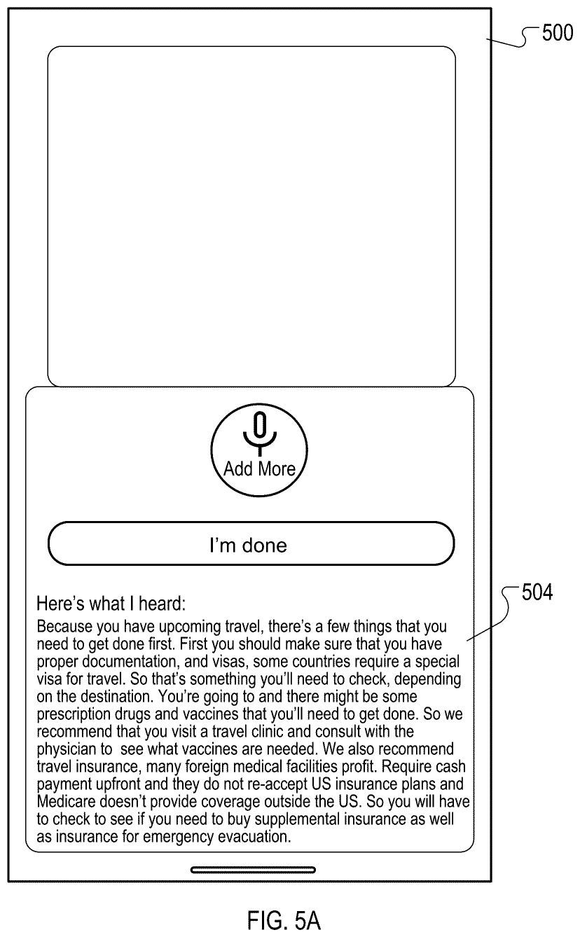

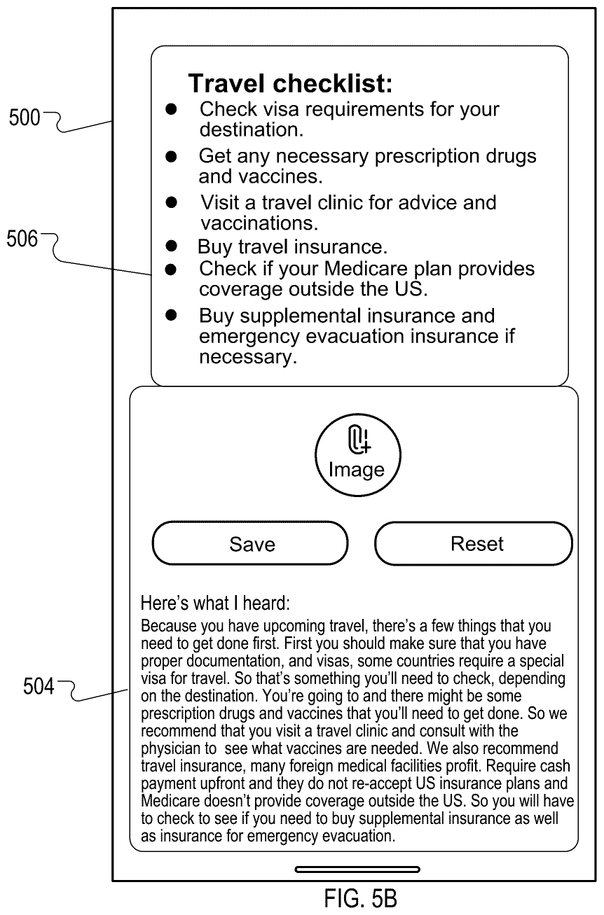

FIGS. 5A and 5B show an example 500 of a live transcription and a modified transcription generated by a user device.

The live transcription 504 reads “Because you have upcoming travel, there's a few things that you need to get done first. First you should make sure that you have proper documentation, and visas, some countries require a special visa for travel. So that's something you'll need to check, depending on the destination. You're going to and there might be some prescription drugs and vaccines that you'll need to get done. So we recommend that you visit a travel clinic and consult with the physician to see what vaccines are needed. We also recommend travel insurance, many foreign medical facilities profit. Require cash payment upfront and they do not re-accept US insurance plans and Medicare doesn't provide coverage outside the US. So you will have to check to see if you need to buy supplemental insurance as well as insurance for emergency evacuation.”.

The device can receive a prompt to generate a list of action items, specifically a travel checklist. When the device receives a prompt to generate a travel checklist, as shown in FIG. 5B, the device can generate a travel checklist 506 based on the live transcription 504 that does not include grammatical errors. The travel checklist 506 reads:

### “Travel Checklist:

Check visa requirements for your destination.
Get any necessary prescription drugs and vaccines.
Visit a travel clinic for advice and vaccinations.
Buy travel insurance.
Check if your Medicare plan provides coverage outside the US.
Buy supplemental insurance and emergency evacuation insurance if necessary.”

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated clectrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments. and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A user electronic device comprising:
one or more microphones configured to capture raw audio data; and
one or more processors and one or more storage devices storing instructions that when executed by the one or more computers cause the one or more computers to perform operations comprising:
receiving the raw audio data captured by the one or more microphones;
processing the raw audio data using a speech transcriber to generate a live transcription of the raw audio data that comprises a plurality of text tokens;
processing the raw audio data to generate a speaker identification output that identifies, for each of the text tokens, a respective speaker for each of the text tokens in the live transcription;
generating an input text by modifying the live transcription to insert text identifying the respective speakers for each of the text tokens in the live transcription; and
processing a first input comprising (i) a first input prompt and (ii) the input text generated from the live transcription using a language model neural network to generate a modified transcription.

2. The user electronic device of claim 1, wherein the modified transcription is a corrected transcription that corrects transcription errors in the live transcription.

3. The user electronic device of claim 2, the operations further comprising:
processing a second input comprising a second prompt for a text analysis task and context data comprising the corrected transcription and using the language model neural network to generate a text output for the text analysis task for the corrected transcription.

4. The user electronic device of claim 3, wherein the second prompt comprises an instruction to identify action items for a particular speaker, wherein the action items comprise (1) questions for the speaker to answer, (2) tasks for the speaker to complete, or both, and the text output comprises text derived from the corrected transcription that identifies one or more action items for the particular speaker.

5. The user electronic device of claim 3, wherein the second prompt comprises an instruction to summarize the corrected transcript and the text output comprises text that summarizes the corrected transcript.

6. The user electronic device of claim 1, wherein the first input prompt comprises an instruction to correct the live transcription.

7. The user electronic device of claim 2, wherein the large language model provides a summary of the audio data at predetermined time intervals.

8. The user electronic device of claim 7, the operations further comprising:
determining that a specified time interval has elapsed since a prior live transcription of raw audio has been processed using the language model neural network; and
processing the first input using the language model neural network in response to determining that the specified time interval has elapsed, wherein the live transcription is a transcription of raw audio captured during the specified time interval.

9. The user electronic device of claim 3, wherein either the first input prompt or the second prompt or both include comprise an instruction to correct transcriptions generated from earlier live transcriptions of raw audio before the specified time interval.

10. The user electronic device of claim 8, the operations further comprising:
determining that transcribing has terminated; and,
in response to determining that transcribing has terminated, processing a final input to generate text that summarizes the live transcription of raw audio data captured prior to, during, and after the specified time interval.

11. The user electronic device of claim 1, wherein the plurality of text tokens comprise a set of speaker identifiers and a block of text associated with each speaker identifier.

12. The user electronic device of claim 1, wherein the prompt comprises a query to correct the live transcription and one or more additional instructions.

13. The user electronic device of claim 1, the operations further comprising outputting the modified transcription to a user of the user electronic device.

14. The user electronic device of claim 6, wherein the first input prompt further comprises an instruction to identify action items for a particular speaker.

15. The user electronic device of claim 6, wherein the first input prompt further comprises an instruction to summarize the corrected transcript.
